(19) United States
(12) Patent Application Publication
(10) Pub. No.: US 2015/0071331 A1
(43) Pub. Date: Mar. 12, 2015

(54) TRANSMISSION DEVICE AND BANDWIDTH ADJUSTMENT METHOD

(71) Applicant: Panasonic Corporation, Osaka (JP)

(72) Inventor: Tatsuya Morishita, Shiga (JP)

(21) Appl. No.: 14/394,674

(22) PCT Filed: Mar. 13, 2014
(86) PCT No.: PCT/JP2014/001435

§ 371 Date: Oct. 15, 2014

(30) Foreign Application Priority Data
Mar. 14, 2013 (JP) 2013-051626

(51) Int. Cl. H04L 1/00; H04L 27/12; H04B 1/7097

(52) U.S. Cl. CPC H04L 1/0034; H04L 1/0002; H04B 1/7097; H04L 27/12; H04L 1/0036
USPC 375/146; 375/296; 375/340

(57) ABSTRACT

A transmitting apparatus is disclosed that adjusts an occupied bandwidth for each transmission rate, and thus can prevent deterioration of an S/N ratio while preventing a situation in which frequency components are cut and cannot be demodulated, without increasing the manufacturing cost. The transmitting apparatus is capable of performing communication at multiple different transmission rates. A modulation section modulates transmission data to generate a modulated signal and adjusts an occupied bandwidth in a passband of a channel selection filter for each of the transmission rates. An occupied bandwidth control section outputs to the modulation section bandwidth setting information that causes a bandwidth to approximate to the bandwidth of a passband of a channel selection filter based on the inputted transmission rate setting information. An RF transmitting section transmits the modulated signal obtained by adjusting the occupied bandwidth via an antenna.

### TECHNICAL FIELD

The present invention relates to a transmitting apparatus capable of performing communication at a plurality of different transmission rates and also to a bandwidth adjusting method.

### BACKGROUND ART

PTL 1 is known as a radio transmission scheme that makes a conventional transmission rate variable.

In the radio transmission scheme of PTL 1, a transmitting apparatus transmits radio signals compliant with a plurality of specifications differing in the occupied bandwidth, baseband filter band and bit rate or the like. That is, the transmitting apparatus transmits radio signals of a plurality of different transmission rates.

A receiving apparatus receives radio signals transmitted from the above-described transmitting apparatus and converts the radio signals arriving at an antenna to intermediate frequency signals in an RF receiving section. The intermediate frequency signals are demodulated by a demodulator, caused to pass through a band pass filter, and converted to digital signals by an A/D converter. The band pass filter is a filter used for the purpose of removing unnecessary noise by allowing a necessary detection signal to pass through the filter, and configured to allow a signal having the widest bandwidth among signals compliant with various specifications to be received to pass through the filter. That is, the band pass filter has a passband that matches the occupied bandwidth of a signal having a high transmission rate.

### CITATION LIST

### Patent Literature

### PTL 1

Japanese Patent Application Laid-Open No. 2010-278741

### SUMMARY OF INVENTION

### Technical Problem

However, according to the radio transmission scheme in PTL 1, when the band pass filter removes a noise component of the signal having a narrow occupied bandwidth and a low transmission rate, the power of the signal components is reduced so that there arises a problem in that an S/N ratio deteriorates. On the other hand, when a band pass filter having a passband that matches the occupied bandwidth of a low transmission rate signal is used to improve the S/N ratio of the low transmission rate signal, there is a problem in that the frequency component of the high transmission rate signal is cut and cannot be demodulated. Moreover, when band pass filters having different passbands corresponding to the signals of respective transmission rates are used, there is a problem in that the manufacturing cost increases.

An object of the present invention is to provide a transmitting apparatus and a bandwidth adjusting method that adjust an occupied bandwidth for each transmission rate, and thus can prevent deterioration of an S/N ratio while preventing a situation in which frequency components are cut and cannot be demodulated, without increasing the manufacturing cost.

### Solution to Problem

A transmitting apparatus according to an aspect of the present invention is an apparatus that performs communication at a plurality of different transmission rates, the apparatus including: an adjusting section that modulates transmission data to generate a transmission signal, and that adjusts, for each of the transmission rates, an occupied bandwidth in a predetermined band of the transmission signal such that the occupied bandwidth approximates to a bandwidth of the predetermined band; and a transmitting section that transmits the transmission signal whose occupied bandwidth has been adjusted by the adjusting section.

A bandwidth adjusting method according to an aspect of the present invention is a method in a transmitting apparatus that performs communication at a plurality of different transmission rates, the method including: modulating transmission data to generate a transmission signal; and adjusting, for each of the transmission rates, an occupied bandwidth in a predetermined band of the transmission signal such that the occupied bandwidth approximates to a bandwidth of the predetermined band.

### Advantageous Effects of Invention

The present invention adjusts an occupied bandwidth for each transmission rate, and thus can prevent deterioration of an S/N ratio while preventing a situation in which a frequency component is cut and cannot be demodulated, without increasing the manufacturing cost.

### BRIEF DESCRIPTION OF DRAWINGS

FIG. 1 is a block diagram illustrating a configuration of a radio transmission system according to Embodiment 1 of the present invention;

FIG. 2 is a block diagram illustrating a configuration of an occupied bandwidth control section according to Embodiment 1 of the present invention;

FIG. 3 is a block diagram illustrating a configuration of an RF receiving section according to Embodiment 1 of the present invention;

FIG. 4 is a block diagram illustrating a configuration of a rate determining section according to Embodiment 1 of the present invention;

FIG. 5 is a block diagram illustrating a configuration of a frequency analysis section according to Embodiment 1 of the present invention;

FIGS. 6A and 6B illustrate occupied bandwidths of modulated signals having a high transmission rate and a low transmission rate according to Embodiment 1 of the present invention;

FIG. 7 is a block diagram illustrating a configuration of a frequency analysis section according to Embodiment 2 of the present invention;

FIG. 8 is a block diagram illustrating a configuration of a frequency analysis section according to Embodiment 3 of the present invention;

FIG. 9 is a block diagram illustrating a configuration of a modulation section according to Embodiment 4 of the present invention;

FIG. 10 is a block diagram illustrating a configuration of a radio transmission system according to Embodiment 5 of the present invention; and

FIG. 11 is a block diagram illustrating a configuration of an occupied bandwidth control section according to Embodiment 5 of the present invention.

### DESCRIPTION OF EMBODIMENTS

Hereinafter, embodiments of the present invention will be described in detail with reference to the accompanying drawings.

### Embodiment 1

### Configuration of Radio Transmission System

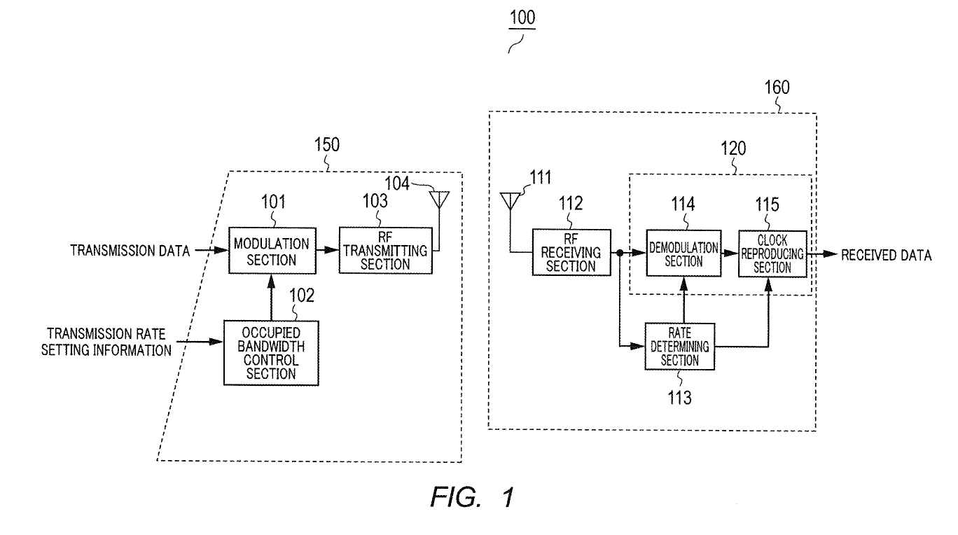

A configuration of radio transmission system 100 according to Embodiment 1 of the present invention will be described with reference to FIG. 1.

Radio transmission system 100 mainly includes transmitting apparatus 150 and receiving apparatus 160.

Transmitting apparatus 150 and receiving apparatus 160 can communicate with each other at a plurality of different transmission rates.

When a mutual distance is small, transmitting apparatus 150 and receiving apparatus 160 perform large-volume communication at a high transmission rate and in a short time. On the other hand, when a mutual distance is large, transmitting apparatus 150 and receiving apparatus 160 set a low transmission rate and secure a wide link budget with high reception sensitivity. This allows radio transmission system 100 to be used for a wide variety of purposes.

<Configuration of Transmitting Apparatus>

A configuration of transmitting apparatus 150 according to Embodiment 1 of the present invention will be described with reference to FIG. 1.

Transmitting apparatus 150 mainly includes modulation section 101, occupied bandwidth control section 102, RF transmitting section 103, and antenna 104. Modulation section 101 and occupied bandwidth control section 102 constitute an adjusting section.

Modulation section 101 modulates inputted transmission data based on bandwidth setting information inputted from occupied bandwidth control section 102 and generates a modulated signal resulting from adjusting for each transmission rate, an occupied bandwidth in a passband of channel selection filter 305 (see FIG. 3) which will be described later of receiving apparatus 160. Modulation section 101 outputs the generated modulated signal to RF transmitting section 103. Here, the bandwidth setting information is, for example, an adjustment coefficient.

Occupied bandwidth control section 102 outputs to modulation section 101, bandwidth setting information that causes a bandwidth to approximate to the bandwidth of a passband of channel selection filter 305 based on the inputted transmission rate setting information. Here, the transmission rate setting information is information indicating a transmission rate predetermined for every transmission data. Details of the configuration of occupied bandwidth control section 102 and the method of adjusting an occupied bandwidth will be described later.

RF transmitting section 103 applies predetermined radio processing to the modulated signal inputted from modulation section 101. RF transmitting section 103 transmits the signal subjected to the radio processing via antenna 104.

<Configuration of Receiving Apparatus>

A configuration of receiving apparatus 160 according to Embodiment 1 of the present invention will be described with reference to FIG. 1.

Receiving apparatus 160 mainly includes antenna 111, RF receiving section 112, rate determining section 113, demodulation section 114 and clock reproducing section 115. Data acquisition processing section 120 includes demodulation section 114 and clock reproducing section 115. Data acquisition processing section 120 performs processing of acquiring received data from a baseband signal.

RF receiving section 112 applies predetermined radio processing to a signal received via antenna 111 and generates a baseband signal. RF receiving section 112 outputs the generated baseband signal to rate determining section 113 and demodulation section 114. The baseband signal outputted from RF receiving section 112 is inputted to rate determining section 113 and demodulation section 114 in parallel. Details of the configuration of RF receiving section 112 will be described later.

Rate determining section 113 analyzes a frequency component of the baseband signal inputted from RF receiving section 112 and determines a transmission rate. When the determined transmission rate is not a predetermined transmission rate, rate determining section 113 sets a parameter corresponding to the determined transmission rate. Rate determining section 113 outputs the set parameter to demodulation section 114 and clock reproducing section 115. When the determined transmission rate is the predetermined transmission rate, rate determining section 113 does not set any parameter. Here, the parameter is, for example, the frequency of a reference clock used to perform digital signal processing, sampling frequency of signal processing, factor of a digital filter, or the number of taps of the digital filter. Details of the configuration of rate determining section 113 will be described later.

Demodulation section 114 includes a preset parameter of a predetermined transmission rate and demodulates, when no parameter is inputted from rate determining section 113, the baseband signal inputted from RF receiving section 112 based on the preset parameter and generates a demodulated signal. When a parameter is inputted from rate determining section 113, demodulation section 114 demodulates the baseband signal inputted from RF receiving section 112 based on the inputted parameter and generates a demodulated signal. Demodulation section 114 outputs the generated demodulated signal to clock reproducing section 115.

Clock reproducing section 115 includes a preset parameter of a predetermined transmission rate and reproduces, when no parameter is inputted from rate determining section 113, a clock from the demodulated signal inputted demodulation section 114 based on the preset parameter and converts the clock to bit data. When a parameter is inputted from rate determining section 113, clock reproducing section 115 reproduces a clock from the demodulated signal inputted from demodulation section 114 based on the inputted parameter and converts the clock to bit data. Clock reproducing section 115 outputs the bit data as received data.

<Configuration of Occupied Bandwidth Control Section>

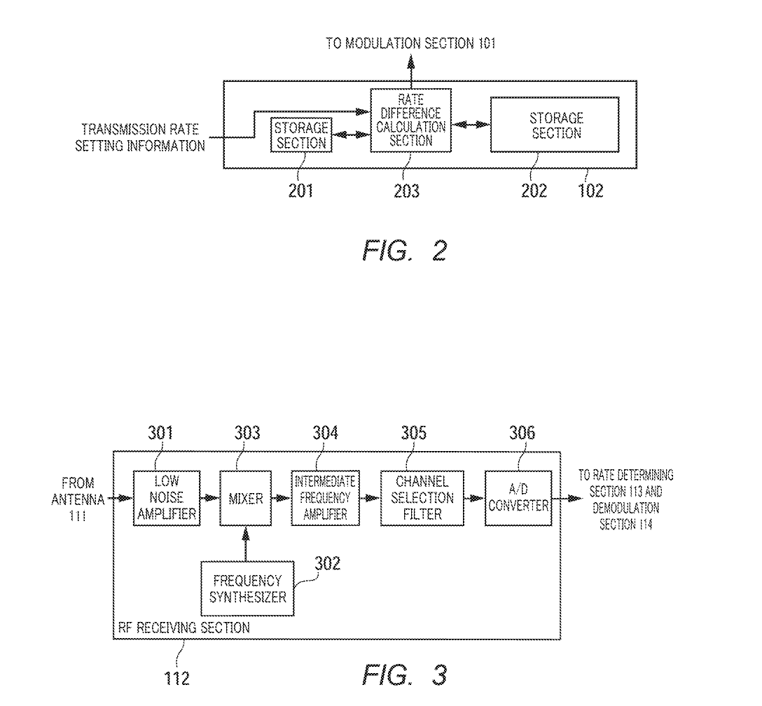

A configuration of occupied bandwidth control section 102 according to Embodiment 1 of the present invention will be described with reference to FIG. 2. A case will be described in FIG. 2 where an adjustment coefficient is used as bandwidth setting information as an example.

Occupied bandwidth control section 102 mainly includes storage section 201, storage section 202, and rate difference calculation section 203.

Storage section 201 stores the fastest transmission rate among transmission rates that can be transmitted from transmitting apparatus 150.

Storage section 202 stores a table that lists rate differences associated with adjustment coefficients.

Upon receiving transmission rate setting information, rate difference calculation section 203 calculates a rate difference between the transmission rate of the transmission rate setting information and the transmission rate stored in storage section 201. With reference to the table stored in storage section 202, rate difference calculation section 203 selects an adjustment coefficient associated with the calculated rate difference. Rate difference calculation section 203 outputs the selected adjustment coefficient to modulation section 101.

When the above-described rate difference is “0,” rate difference calculation section 203 does not select any adjustment coefficient. The case where the above-described rate difference is “0” is a case where it is not necessary to adjust the occupied bandwidth because the transmission rate of the transmission data to be transmitted from now on is fastest. Rate difference calculation section 203 may also be configured not to select any adjustment coefficient when the above-described rate difference is less than a threshold. This is applicable to a case where, at a transmission rate slightly lower than the fastest transmission rate, the signal has a relatively broad occupied bandwidth, and the occupied bandwidth thereby need not be adjusted.

For example, when fastest transmission rate xₙ[bps] having occupied bandwidth yₙ[Hz] is stored in storage section 201, and when transmission rate setting information of low transmission rate xm having occupied bandwidth yₘ is inputted, rate difference calculation section 203 multiplies occupied bandwidth yₘ by α (α>1) and outputs adjustment coefficient α to cause occupied bandwidth yₘ to approximate to occupied bandwidth yₙ to modulation section 101.

<Configuration of RF Receiving Section>

A configuration of RF receiving section 112 according to Embodiment 1 of the present invention will be described with reference to FIG. 3.

RF receiving section 112 mainly includes low noise amplifier 301, frequency synthesizer 302, mixer 303, intermediate frequency amplifier 304, channel selection filter 305, and A/D converter 306.

Low noise amplifier 301 amplifies a signal received at antenna 111 and outputs the amplified signal to mixer 303.

Frequency synthesizer 302 generates a reference signal of a predetermined frequency and outputs the reference signal to mixer 303.

Mixer 303 mixes the signal inputted from low noise amplifier 301 and a reference signal inputted from frequency synthesizer 302 and generates an intermediate frequency signal. Mixer 303 outputs the generated intermediate frequency signal to intermediate frequency amplifier 304.

Intermediate frequency amplifier 304 amplifies the intermediate frequency signal inputted from mixer 303 and outputs the amplified intermediate frequency signal to channel selection filter 305.

Channel selection filter 305 is provided to remove a noise component. Channel selection filter 305 allows a predetermined passband of the intermediate frequency signal inputted from intermediate frequency amplifier 304 to pass through the filter and prevents bands other than the passband from passing through the filter.

A/D converter 306 converts the intermediate frequency signal of the passband inputted from channel selection filter 305 from an analog signal format to a digital signal format and outputs the digital signal to rate determining section 113 and demodulation section 114 as a baseband signal.

<Configuration of Rate Determining Section>

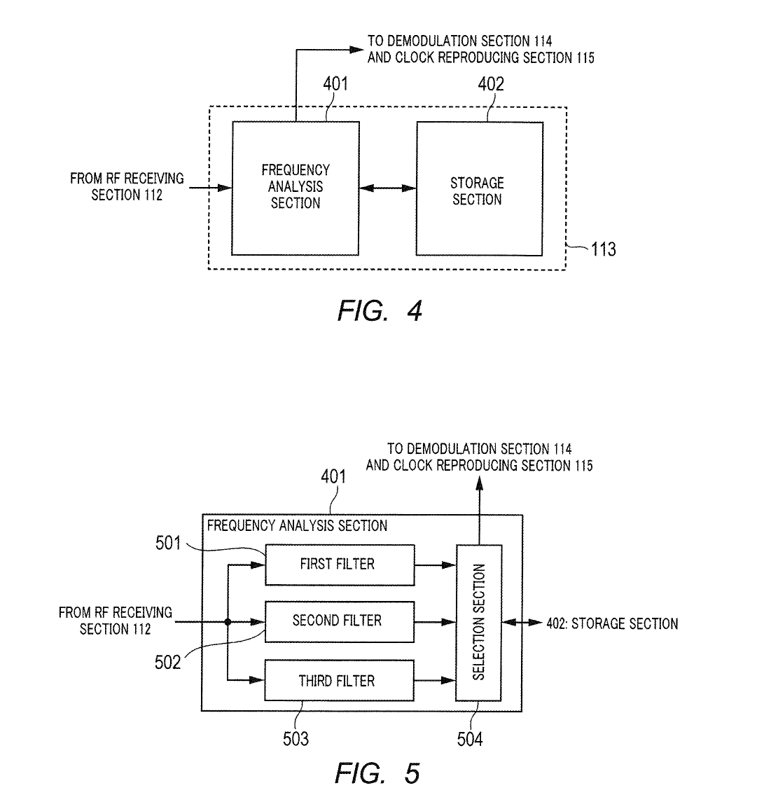

A configuration of rate determining section 113 according to Embodiment 1 of the present invention will be described with reference to FIG. 4.

Rate determining section 113 includes frequency analysis section 401 and storage section 402.

Frequency analysis section 401 analyzes a frequency component of the baseband signal inputted from RF receiving section 112 and determines a transmission rate. Frequency analysis section 401 selects and sets a parameter associated with the determined transmission rate with reference to a table stored in storage section 402 and outputs the set parameter to demodulation section 114 and clock reproducing section 115. When there is no parameter associated with the determined transmission rate, frequency analysis section 401 outputs nothing.

Storage section 402 stores a table that lists transmission rates associated with parameters. The table dose not store any parameter preset in demodulation section 114 and clock reproducing section 115.

Here, the synchronization frame detection section of PTL 1 determines the transmission rate after demodulating the modulated signal into bit data, and therefore it has a harmful effect that the header portion of a frame becomes longer and a frame for determining a transmission rate is necessary. On the other hand, the present embodiment determines the transmission rate by analyzing a frequency component of a modulated signal, and thus can determine the transmission rate before demodulating the modulated signal into bit data. As a result, the present embodiment can solve the above-described harmful effect.

<Configuration of Frequency Analysis Section>

A configuration of frequency analysis section 401 according to Embodiment 1 of the present invention will be described with reference to FIG. 5.

Frequency analysis section 401 mainly includes first filter 501, second filter 502, third filter 503, and selection section 504.

First filter 501 allows only a frequency f1 component of the baseband signal inputted from RF receiving section 112 to pass through the filter.

Second filter 502 allows only a frequency f2 component of the baseband signal inputted from RF receiving section 112 to pass through the filter.

Third filter 503 allows only a frequency f3 component of the baseband signal inputted from RF receiving section 112 to pass through the filter.

Selection section 504 analyzes the frequency component from the baseband signal inputted after passing through first filter 501, second filter 502 or third filter 503.

Selection section 504 determines a transmission rate from the analyzed frequency component. With reference to the table stored in storage section 402, selection section 504 selects and sets a parameter associated with the determined transmission rate. Selection section 504 outputs the set parameter to demodulation section 114 and clock reproducing section 115. When there is no parameter associated with the determined transmission rate, selection section 504 outputs nothing.

<Method of Adjusting Occupied Bandwidth>

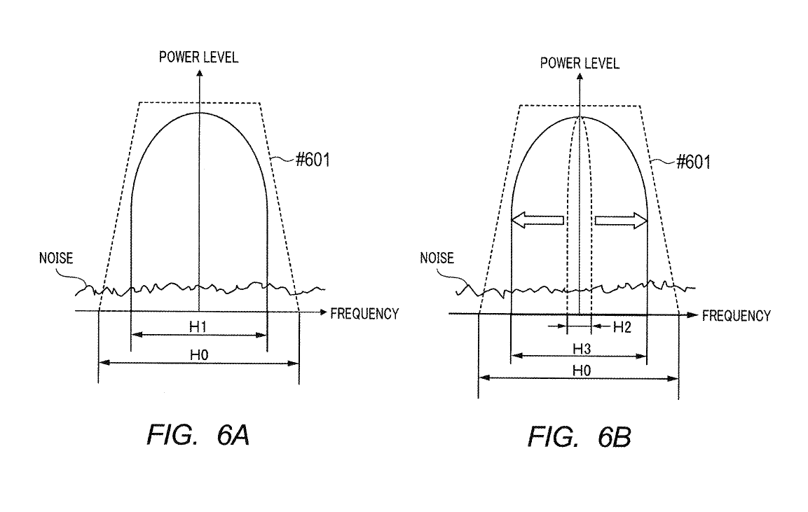

The method of adjusting an occupied bandwidth according to Embodiment 1 of the present invention will be described with reference to FIG. 6. In FIGS. 6A and 6B, FIG. 6A illustrates an occupied bandwidth of a modulated signal having a high transmission rate and FIG. 6B illustrates an occupied bandwidth of a modulated signal having a low transmission rate. A case will be described in FIG. 6 where an adjustment coefficient is used as bandwidth setting information as an example.

Channel selection filter 305 is generally adjusted so as to minimize noise power, with passband #601 that will not cut the occupied bandwidth of a modulated signal having a high transmission rate set therein.

In the case of a high transmission rate, since occupied bandwidth H1 is sufficiently large compared to bandwidth H0 of passband #601 of channel selection filter 305 as shown in FIG. 6A, occupied bandwidth control section 102 leaves occupied bandwidth H1 as is without any adjustment.

On the other hand, occupied bandwidth H2 of the modulated signal having a low transmission rate is narrower than bandwidth H0 of passband #601 of channel selection filter 305 as shown in FIG. 6B. As a result, signal power decreases and an S/N ratio deteriorates in the modulated signal having a low transmission rate.

Therefore, in the present embodiment, occupied bandwidth control section 102 outputs adjustment coefficient α for adjusting occupied bandwidth H2 to modulation section 101. When generating a modulated signal, modulation section 101 multiplies occupied bandwidth H2 by adjustment coefficient α (α>1) to expand occupied bandwidth H2 to occupied bandwidth H3 (H3=H2×α). That is, modulation section 101 makes an adjustment so that the occupied bandwidth in the case of a low transmission rate approximates to bandwidth H0 of passband #601 of channel selection filter 305.

Assuming that noise power per Hz is N0, the bandwidth of passband of channel selection filter 305 is BW, power of a modulated signal at a conventional low transmission rate is S_Low0, and power of a modulated signal at a low transmission rate of the present embodiment is S_Low1, the S/N ratio at the low transmission rate according to the present embodiment is as shown in Equation 1.

$$\begin{matrix}S \text{/} N ratio = S\_Low 1 \text{/} ( N 0 \times BW ) \\ = ( S\_Low 0 \times α ) \text{/} ( N 0 \times BW )\end{matrix} \qquad ( Equation 1 )$$

It is understandable from Equation 1 that the S/N ratio at the low transmission rate according to the present embodiment is multiplied by a and improved compared to the S/N ratio at the conventional low transmission rate.

Occupied bandwidth H3 after adjustment may be equal to occupied bandwidth H1 (H1=H3) or may be greater than occupied bandwidth H1 (H1<H3) or may be smaller than occupied bandwidth H1 (H1>H3) if it falls within passband #601.

For example, when the low transmission rate is 1 kbps and the high transmission rate is 1 Mbps, the rate difference becomes 1000-fold. Therefore, occupied bandwidth control section 102 selects adjustment coefficient α such that the occupied bandwidth approximates to an occupied bandwidth value which is 1000 times the occupied bandwidth of the inputted low transmission rate of 1 kbps and adjusts the occupied bandwidth.

As described above, it is possible to prevent deterioration of an S/N ratio by expanding the occupied bandwidth in the case of a low transmission rate. The passband of channel selection filter 305 is set according to the occupied bandwidth of the high transmission rate. As a result, the frequency component of a signal having a high transmission rate is never cut in receiving apparatus 160.

### Effects of Embodiment 1

According to the present embodiment, adjusting the occupied bandwidth for each transmission rate makes it possible to prevent the S/N ratio from deteriorating while preventing a situation in which a frequency component is cut and cannot be demodulated, without increasing cost.

According to the present embodiment, the frequency component is analyzed with the first filter, second filter and third filter connected in parallel, so that it is possible to perform the processing of selecting a parameter fast.

### Variation of Embodiment 1

Although an adjustment coefficient is used as bandwidth setting information in the present embodiment, it is also possible to adjust the occupied bandwidth using optional parameters or information other than the adjustment coefficient.

### Embodiment 2

### Configuration of Frequency Analysis Section

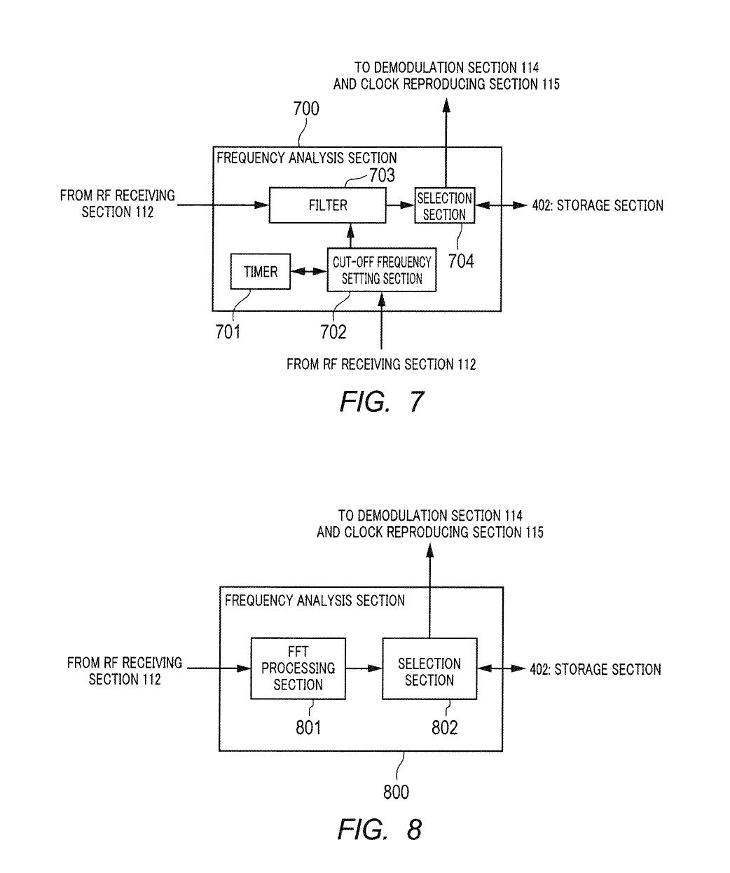

A configuration of frequency analysis section 700 according to Embodiment 2 of the present invention will be described with reference to FIG. 7. The configuration of the rate determining section of the present embodiment has the same configuration as that in FIG. 4 except in that frequency analysis section 700 is provided instead of frequency analysis section 401, and therefore the description thereof will be omitted. Moreover, the configuration other than the rate determining section and the method of adjusting an occupied bandwidth are the same as those of Embodiment 1 above, and therefore the description thereof will be omitted.

Frequency analysis section 700 mainly includes timer 701, cut-off frequency setting section 702, filter 703, and selection section 704.

Timer 701 measures a time according to an instruction from cut-off frequency setting section 702 and outputs the measurement result to cut-off frequency setting section 702.

When a baseband signal is inputted from RF receiving section 112, cut-off frequency setting section 702 causes timer 701 to start time measurement. Cut-off frequency setting section 702 performs control of changing a cut-off frequency of filter 703 in a predetermined cycle based on the time measurement result inputted from timer 701.

Filter 703 changes the cut-off frequency according to the control of cut-off frequency setting section 702. Filter 703 prevents a cut-off frequency of the baseband signal inputted from RF receiving section 112 from passing through the filter and allows frequencies other than the cut-off frequency to pass through the filter.

Selection section 704 analyzes the frequency component from the baseband signal inputted after passing through filter 703. Selection section 704 determines the transmission rate from the analyzed frequency component. Selection section 704 selects and sets a parameter associated with the determined transmission rate with reference to the table stored in storage section 402, and outputs the set parameter to demodulation section 114 and clock reproducing section 115. When there is no parameter associated with the determined transmission rate, selection section 704 outputs nothing.

### Effects of Embodiment 2

According to the present embodiment, adjusting the occupied bandwidth for each transmission rate makes it possible to prevent deterioration of an S/N ratio while preventing a situation in which a frequency component is cut and cannot be demodulated, without increasing the manufacturing cost.

The present embodiment analyzes the frequency component while changing the cut-off frequency using a single filter and selects a parameter, and thus can reduce the circuit scale and the occupied area of the circuit on the substrate on which the receiving apparatus is mounted.

### Variation of Embodiment 2

The adjustment coefficient is used as bandwidth setting information in the present embodiment, but it is possible to use optional parameters or information other than the adjustment coefficient to adjust the occupied bandwidth.

### Embodiment 3

### Configuration of Frequency Analysis Section

A configuration of frequency analysis section 800 according to Embodiment 3 of the present invention will be described with reference to FIG. 8. The configuration of the rate determining section according to the present embodiment is the same as the configuration in FIG. 4 except in that frequency analysis section 800 is provided instead of frequency analysis section 401, and therefore the description thereof will be omitted. Moreover, the configuration other than the rate determining section and the method of adjusting an occupied bandwidth are the same as those of Embodiment 1 above, and therefore the description thereof will be omitted.

Frequency analysis section 800 mainly includes FFT processing section 801 and selection section 802.

FFT processing section 801 performs FFT processing on a baseband signal inputted from RF receiving section 112 to transform the baseband signal from a time-domain signal into a frequency-domain signal and outputs the frequency-domain signal to selection section 802.

Selection section 802 analyzes a frequency component from the frequency-domain signal after the FFT processing inputted from FFT processing section 801. Selection section 802 determines a transmission rate from the analyzed frequency component. With reference to the table stored in storage section 402, selection section 802 selects and sets a parameter associated with the determined transmission rate and outputs the set parameter to demodulation section 114 and clock reproducing section 115. When there is no parameter associated with the determined transmission rate, selection section 802 outputs nothing.

### Effects of Embodiment 3

The present invention adjusts an occupied bandwidth for each transmission rate, and thus can prevent deterioration of an S/N ratio while preventing a situation in which a frequency component is cut and cannot be demodulated, without increasing the manufacturing cost.

In addition, the present embodiment analyzes a frequency component through FFT processing, and thus can perform a frequency analysis with high accuracy, select an optimum parameter and perform processing such as AGC (Automatic Gain Control) or the like in parallel.

### Variation of Embodiment 3

Although an adjustment coefficient is used as bandwidth setting information in the present embodiment, it is also possible to adjust the occupied bandwidth using optional parameters or information other than the adjustment coefficient.

### Embodiment 4

### Configuration of Modulation Section

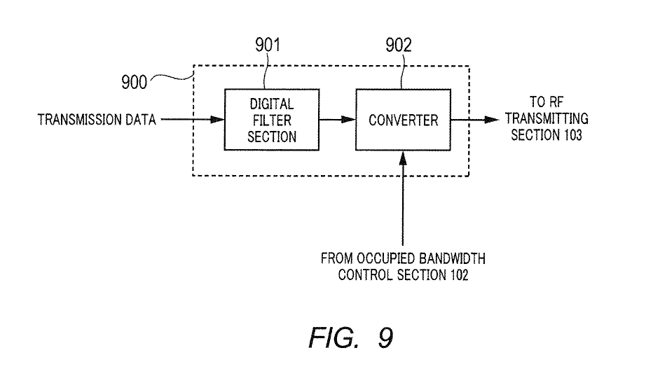

A configuration of modulation section 900 according to Embodiment 4 of the present invention will be described with reference to FIG. 9. The configuration of a transmitting apparatus according to the present embodiment has the same configuration as that in FIG. 1 except in that modulation section 900 is provided instead of modulation section 101, and therefore the description thereof will be omitted. Moreover, the configuration other than the transmitting apparatus of the present embodiment is the same as that of Embodiment 1 above, and therefore the description thereof will be omitted.

Modulation section 900 mainly includes digital filter section 901 and converter 902.

Digital filter section 901 allows a predetermined band of inputted transmission data to pass through the filter.

Converter 902 frequency-modulates the transmission data that has passed through digital filter section 901 while changing a control voltage at predetermined resolution which is bandwidth setting information inputted from occupied bandwidth control section 102 and thereby generates an FSK (frequency-shift keying) modulated signal. Converter 902 outputs the generated FSK modulated signal to RF transmitting section 103. Converter 902 is, for example, a voltage-controlled oscillator (VCO).

For example, when the low transmission rate is 1 kbs and the high transmission rate is 1 Mbps, the rate difference becomes 1000-fold. Therefore, converter 902 can broaden the occupied bandwidth of a modulated signal when a low transmission rate is used by adjusting the resolution so as to approximate to 1000-fold according to control of occupied bandwidth control section 102.

When a Gaussian filter is used for digital filter section 901, modulation section 900 can generate a GFSK modulated signal.

The method of adjusting an occupied bandwidth according to the present embodiment is the same as that of Embodiment 1 above except in that resolution is used instead of an adjustment coefficient, and therefore the description thereof will be omitted.

### Effects of Embodiment 4

The present invention adjusts an occupied bandwidth for each transmission rate, and thus can prevent deterioration of an S/N ratio while preventing a situation in which a frequency component is cut and cannot be demodulated.

Moreover, the present embodiment performs modulation using an FSK modulation scheme and adjusts an occupied bandwidth by adjusting the resolution in frequency conversion, and thus can adjust the occupied bandwidth using a simple method.

### Embodiment 5

### Configuration of Radio Transmission System

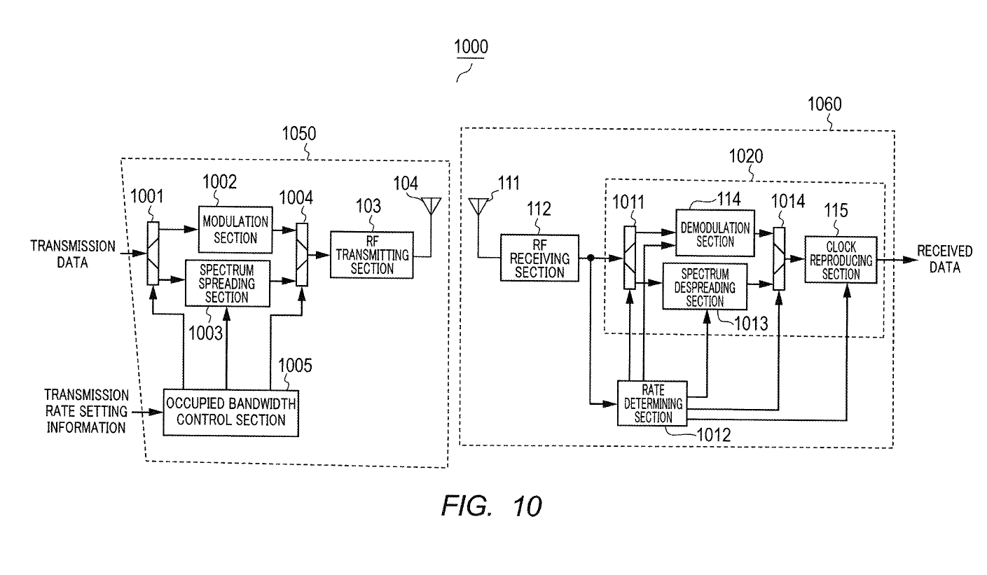

A configuration of radio transmission system 1000 according to Embodiment 5 of the present invention will be described with reference to FIG. 10.

Radio transmission system 1000 mainly includes transmitting apparatus 1050 and receiving apparatus 1060.

Transmitting apparatus 1050 and receiving apparatus 1060 can communicate with each other at a plurality of different transmission rates.

When the mutual distance is small, transmitting apparatus 1050 and receiving apparatus 1060 perform large-volume communication at a high transmission rate and in a short time. On the other hand, when the mutual distance is large, transmitting apparatus 1050 and receiving apparatus 1060 set a low transmission rate and secure a wide link budget at high reception sensitivity. This allows radio transmission system 100 to be used for a wide variety of purposes.

<Configuration of Transmitting Apparatus>

A configuration of transmitting apparatus 1050 according to Embodiment 5 of the present invention will be described with reference to FIG. 10.

Compared to transmitting apparatus 150 according to Embodiment 1 shown in FIG. 1, transmitting apparatus 1050 shown in FIG. 10 is additionally provided with switch section 1001, spectrum spreading section 1003 and switch section 1004, and includes modulation section 1002 instead of modulation section 101 and occupied bandwidth control section 1005 instead of occupied bandwidth control section 102. Parts in FIG. 10 having the same configuration as that in FIG. 1 are assigned the same reference numerals and the description thereof will be omitted.

Transmitting apparatus 1050 mainly includes RF transmitting section 103, antenna 104, switch section 1001, modulation section 1002, spectrum spreading section 1003, switch section 1004, and occupied bandwidth control section 1005.

Switch section 1001 switches between the output of inputted transmission data to modulation section 1002 and the output of inputted transmission data to spectrum spreading section 1003 according to the control of occupied bandwidth control section 1005.

Modulation section 1002 modulates transmission data inputted via switch section 1001 and generates a modulated signal. Modulation section 1002 outputs the generated modulated signal to RF transmitting section 103 via switch section 1004.

Spectrum spreading section 1003 modulates the transmission data inputted via switch section 1001 and generates a modulated signal. Spectrum spreading section 1003 performs spreading processing on the modulated signal using a spreading code which is bandwidth setting information inputted from occupied bandwidth control section 1005 using a predetermined spreading factor and generates a spread signal obtained by adjusting the occupied bandwidth in a passband of channel selection filter 305 of receiving apparatus 1060 for each transmission rate. Spectrum spreading section 1003 outputs the generated spread signal to RF transmitting section 103 via switch section 1004.

Switch section 1004 switches between the output of the modulated signal inputted from modulation section 1002 to RF transmitting section 103 and the output of the spread signal inputted from spectrum spreading section 1003 to RF transmitting section 103 according to the control of occupied bandwidth control section 1005.

RF transmitting section 103 applies predetermined radio processing to the modulated signal or spread signal inputted from modulation section 1002 or spectrum spreading section 1003 via switch section 1004. RF transmitting section 103 transmits the signal subjected to the radio processing via antenna 104.

Occupied bandwidth control section 1005 outputs a spreading code of a spreading factor that allows approximation to the bandwidth of the passband of channel selection filter 305 to spectrum spreading section 1003 based on the inputted transmission rate setting information. Occupied bandwidth control section 1005 makes the sequence length of a spreading code variable and thereby makes the spreading factor variable. Details of the configuration of occupied bandwidth control section 1005 will be described later.

<Configuration of Receiving Apparatus>

A configuration of the receiving apparatus according to Embodiment 5 of the present invention will be described with reference to FIG. 10.

Compared to receiving apparatus 160 according to Embodiment 1 shown in FIG. 1, receiving apparatus 1060 shown in FIG. 10 is additionally provided with switch section 1011, spectrum despreading section 1013 and switch section 1014 and includes rate determining section 1012 instead of rate determining section 113. Parts in FIG. 10 having the same configuration as that in FIG. 1 are assigned the same reference numerals and the description thereof will be omitted.

Receiving apparatus 1060 mainly includes antenna 111, RF receiving section 112, demodulation section 114, clock reproducing section 115, switch section 1011, rate determining section 1012, spectrum despreading section 1013, and switch section 1014. Data acquisition processing section 1020 includes demodulation section 114, clock reproducing section 115, switch section 1011, spectrum despreading section 1013, and switch section 1014. Data acquisition processing section 1020 performs processing of acquiring received data from a baseband signal.

RF receiving section 112 applies predetermined radio processing to a signal received via antenna 111 and generates a baseband signal. RF receiving section 112 outputs the generated baseband signal to demodulation section 114 via rate determining section 1012 and switch section 1011. The baseband signal outputted from RF receiving section 112 is inputted to rate determining section 1012 and data acquisition processing section 1020 in parallel.

Switch section 1011 switches between the output of the modulated signal inputted from RF receiving section 112 to demodulation section 114 and the output of the spread signal inputted from RF receiving section 112 to spectrum despreading section 1013 according to the control of rate determining section 1012.

Rate determining section 1012 performs despreading processing on the baseband signal inputted from RF receiving section 112, analyzes the frequency component and determines a transmission rate. When the determined transmission rate is not a predetermined transmission rate, rate determining section 1012 sets a parameter corresponding to the determined transmission rate. Rate determining section 1012 outputs the set parameter to demodulation section 114 and clock reproducing section 115. When the determined transmission rate is a predetermined transmission rate, rate determining section 1012 does not set any parameter.

Rate determining section 1012 stores beforehand a table that lists transmission rates associated with spreading codes. Rate determining section 1012 selects a spreading code associated with the determined transmission rate with reference to the table and outputs the spreading code to spectrum despreading section 1013.

Rate determining section 1012 controls the switching by switch section 1011 and switch section 1014 according to the determined transmission rate.

A parameter of a predetermined transmission rate is set beforehand in demodulation section 114 and if no parameter is inputted from rate determining section 1012, demodulation section 114 demodulates the baseband signal inputted from RF receiving section 112 based on the preset parameter and generates a demodulated signal. When a parameter is inputted from rate determining section 1012, demodulation section 114 demodulates the baseband signal inputted from RF receiving section 112 based on the inputted parameter and generates a demodulated signal. Demodulation section 114 outputs the generated demodulated signal to clock reproducing section 115 via switch section 1014.

Spectrum despreading section 1013 despreads the baseband signal inputted from RF receiving section 112 via switch section 1011 using the spreading code inputted from rate determining section 1012. Spectrum despreading section 1013 demodulates the despread signal and generates a demodulated signal. Spectrum despreading section 1013 outputs the demodulated signal to clock reproducing section 115 via switch section 1014. Here, the spreading code inputted from rate determining section 1012 to spectrum despreading section 1013 is identical to the spreading code inputted from occupied bandwidth control section 1005 to spectrum spreading section 1003.

Switch section 1014 switches between the output of the demodulated signal inputted from demodulation section 114 to clock reproducing section 115 and the output of the demodulated signal inputted from spectrum despreading section 1013 to clock reproducing section 115 according to the control of rate determining section 1012.

A parameter of a predetermined transmission rate is set beforehand in clock reproducing section 115 and when no parameter is inputted from rate determining section 1012, clock reproducing section 115 reproduces a clock from the demodulated signal inputted from demodulation section 114 or spectrum despreading section 1013 via switch section 1014 based on the preset parameter and converts the clock to bit data. When a parameter is inputted from rate determining section 1012, clock reproducing section 115 reproduces a clock from the demodulated signal inputted from demodulation section 114 or spectrum despreading section 1013 via switch section 1014 based on the inputted parameter and converts the clock to bit data. Clock reproducing section 115 outputs the bit data as received data.

<Configuration of Occupied Bandwidth Control Section>

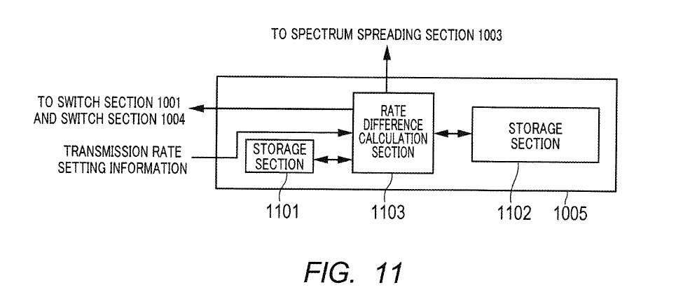

A configuration of occupied bandwidth control section 1005 according to Embodiment 5 of the present invention will be described with reference to FIG. 11.

Occupied bandwidth control section 1005 mainly includes storage section 1101, storage section 1102, and rate difference calculation section 1103.

Storage section 1101 stores the fastest transmission rate among transmission rates that can be transmitted from transmitting apparatus 1050.

Storage section 1102 stores a table that lists rate differences associated with spreading codes of different spreading factors.

When transmission rate setting information is inputted, rate difference calculation section 1103 calculates a rate difference between the transmission rate of the transmission rate setting information and the transmission rate stored in storage section 1101. Rate difference calculation section 1103 selects a spreading code associated with the calculated rate difference with reference to the table stored in storage section 1102. Rate difference calculation section 1103 outputs the selected spreading code to spectrum spreading section 1003.

When the rate difference is other than “0,” rate difference calculation section 1103 controls the switching by switch section 1001 so that transmission data is inputted to spectrum spreading section 1003 and controls the switching by switch section 1004 so that spectrum spreading section 1003 and RF transmitting section 103 are connected. When the calculated rate difference is “0,” rate difference calculation section 1103 controls the switching by switch section 1001 so that transmission data is inputted to modulation section 1002 and controls the switching by switch section 1004 so that modulation section 1002 and RF transmitting section 103 are connected. The case where the above-described rate difference is “0” is a case where the occupied bandwidth need not be adjusted because the transmission rate of transmission data to be transmitted from now is fastest.

When the above-described rate difference is equal to or above a threshold, rate difference calculation section 1103 may control the switching by switch section 1001 so that transmission data is inputted to spectrum spreading section 1003 and may control the switching by switch section 1004 so that spectrum spreading section 1003 and RF transmitting section 103 are connected. On the other hand, when the above-described rate difference is less than a threshold, rate difference calculation section 1103 may control the switching by switch section 1001 so that transmission data is inputted to modulation section 1002 and may control the switching by switch section 1004 so that modulation section 1002 and RF transmitting section 103 are connected. This is applicable to a case where it is not necessary to adjust the occupied bandwidth because a relatively wide occupied bandwidth is provided at a slightly lower transmission rate than the fastest transmission rate.

The method of adjusting an occupied bandwidth according to the present embodiment is the same as that of Embodiment 1 above except using a spreading code instead of an adjustment coefficient, and therefore the description thereof will be omitted.

### Effects of Embodiment 5

According to the present embodiment, by adjusting an occupied bandwidth for each transmission rate, it is possible to prevent deterioration of an S/N ratio while preventing a situation in which a frequency component is cut and cannot be demodulated.

According to the present embodiment, transmission data is spread and then transmitted, and it is thereby possible to perform communication with high confidentiality and also improve use efficiency of resources.

### Variation Common to all Embodiments

In Embodiment 1 to Embodiment 5 above, the occupied bandwidth of a signal having a low transmission rate has been extended, but the occupied bandwidth of a signal having a high transmission rate may also be reduced.

The disclosure of the specification, drawings, and abstract in Japanese Patent Application No. 2013-051626 filed on Mar. 14, 2013, is incorporated herein by reference in its entirety.

### INDUSTRIAL APPLICABILITY

The present invention is suitable for use in a transmitting apparatus that can perform communication at a plurality of different transmission rates and a bandwidth adjusting method.

### REFERENCE SIGNS LIST

100 Radio transmission system
101 Modulation section
102 Occupied bandwidth control section
103 RF transmitting section
104, 111 Antenna
112 RF receiving section
113 Rate determining section
114 Demodulation section
115 Clock reproducing section
120 Data acquisition processing section
150 Transmitting apparatus
160 Receiving apparatus

1. A transmitting apparatus that performs communication at a plurality of different transmission rates, the transmitting apparatus comprising:
an adjusting section that modulates transmission data to generate a transmission signal, and that adjusts, for each of the transmission rates, an occupied bandwidth in a predetermined band of the transmission signal such that the occupied bandwidth approximates to a bandwidth of the predetermined band; and
a transmitting section that transmits the transmission signal whose occupied bandwidth has been adjusted by the adjusting section.

2. The transmitting apparatus according to claim 1, wherein the predetermined band is a passband of a channel selection filter on a receiving side.

3. The transmitting apparatus according to claim 1, wherein the adjusting section adjusts the occupied bandwidth by multiplying the occupied bandwidth by α (α>1).

4. The transmitting apparatus according to claim 1, wherein the adjusting section applies spread processing to the transmission data in addition to the modulation to generate the transmission signal and performs the adjustment by making a spreading factor of the spread processing variable.

5. The transmitting apparatus according to claim 1, wherein the adjusting section modulates the transmission data according to an FSK modulation scheme to generate the transmission signal and performs the adjustment by making a resolution of frequency conversion according to the FSK modulation scheme variable.

6. A receiving apparatus that communicates with the transmitting apparatus according to claim 1, the receiving apparatus comprising:
a receiving section that receives the transmission signal transmitted from the transmitting section;
a band limiting section that allows a passband which is the predetermined band of the transmission signal received by the receiving section to pass through the band limiting section;
a transmission rate determining section that determines a transmission rate by analyzing a frequency component of the transmission signal which has passed through the band limiting section and that sets a parameter corresponding to the determined transmission rate; and
a data acquisition section that demodulates the transmission signal which has passed through the band limiting section and that acquires data according to the parameter set by the transmission rate determining section.

7. The receiving apparatus according to claim 6, wherein the transmission rate determining section includes a plurality of filters that are connected in parallel and that allow different frequencies to pass through the filters, respectively, wherein the transmission rate determining section allows the transmission signal which has passed through the band limiting section to pass through the filters and thereby analyzes the frequency component.

8. The receiving apparatus according to claim 6, wherein the transmission rate determining section includes a single filter, wherein the transmission rate determining section allows the transmission signal which has passed through the band limiting section to pass through the filter while changing a cut-off frequency and thereby analyzes the frequency component.

9. The receiving apparatus according to claim 6, wherein the transmission rate determining section converts the transmission signal which has passed through the band limiting section from a time-domain signal to a frequency-domain signal and thereby analyzes the frequency component.

10. A bandwidth adjusting method in a transmitting apparatus that performs communication at a plurality of different transmission rates, the method comprising:
modulating transmission data to generate a transmission signal; and
adjusting, for each of the transmission rates, an occupied bandwidth in a predetermined band of the transmission signal such that the occupied bandwidth approximates to a bandwidth of the predetermined band.
